(19) United States
(12) Patent Application Publication
(10) Pub. No.: US 2026/0057685 A1
(43) Pub. Date: Feb. 26, 2026

(54) DETERMINING FAILURE CASES IN TRAINED NEURAL NETWORKS USING GENERATIVE NEURAL NETWORKS

(71) Applicant: DEEPMIND TECHNOLOGIES LIMITED, London (GB)

(72) Inventors: Sven Adrian Gowal, Cambridge (GB); Olivia Anne Wiles, London (GB); Isabela Maria Carneiro de Albuquerque, London (GB)

(21) Appl. No.: 19/104,051

(22) PCT Filed: Aug. 16, 2023
(86) PCT No.: PCT/EP2023/072617

§ 371 Date: Feb. 14, 2025

Related U.S. Application Data
(60) Provisional application No. 63/398,801, filed on Aug. 17, 2022.

(51) Int. Cl. G06V 20/70; G06V 10/764; G06V 10/82

(52) U.S. Cl. CPC G06V 20/70; G06V 10/764; G06V 10/82

(57) ABSTRACT

Methods, systems, and computer readable storage media for performing operations comprising: obtaining a plurality of initial network inputs that have been classified as belonging to a corresponding ground truth class; processing each of the plurality of initial network inputs using a trained target neural network to generate a respective predicted network output for each initial network input, the respective predicted network output comprising a respective score for each of a plurality of classes, the plurality of classes comprising the ground truth class; identifying, based on the respective predicted network outputs and the ground truth class, a subset of the initial network inputs as having been misclassified by the trained target neural network; and determining, based on the subset of initial network inputs, one or more failure case latent representations, wherein each failure case latent representation is a latent representation that characterizes network inputs that belong to the ground truth class but that are likely to be misclassified by the trained target neural network.

### BACKGROUND

This specification relates to performing a machine learning task on a network input using neural networks.

Neural networks are machine learning models that employ one or more layers of nonlinear units to predict an output for a received input. Some neural networks include one or more hidden layers in addition to an output layer. The output of each hidden layer is used as input to the next layer in the network, i.e., the next hidden layer or the output layer. Each layer of the network generates an output from a received input in accordance with current value inputs of a respective set of parameters.

### SUMMARY

This specification describes a system implemented as computer programs on one or more computers in one or more locations that determines failure cases for a trained neural network.

The trained neural network is a neural network that has been trained to perform a classification task.

As used in this specification, a classification task is any task that requires the neural network to generate an output that includes a respective score for each of a set of multiple classes and, in some cases, to then select one or more of the classes as a “classification”for the network input using the respective scores.

The trained neural network can have been trained on a set of training data using an objective function that is appropriate for the classification task. That is, the described techniques are generally applicable to discovering failure cases for any conventionally trained neural network.

A “failure case” as used in this specification is a network input that is likely to be misclassified by the trained neural network or a latent representation that characterizes network inputs that are likely to be misclassified by the trained neural network. For example, the latent representations can be text captions that describe network inputs, e.g., as generated by a captioning neural network by processing the network input. A given network input can be determined to be “likely” to be misclassified by the trained neural network when the system predicts that the likelihood that the trained neural network will misclassify the network input exceeds a baseline misclassification rate by more than a specified amount, where the specified amount is a value greater than or equal to zero and the baseline misclassification rate can be specified by a user or can be determined by determining the rate at which the trained neural network misclassifies a large number of randomly selected inputs or a large number generated inputs.

A network input can be determined to be “misclassified” by a neural network based on any of a variety of criteria. Generally, a network input is misclassified when the predicted output generated by the neural network by processing the network input is inconsistent with a known, ground truth class to which the network input has been classified as belonging.

The subject matter described in this specification can be implemented in particular embodiments so as to realize one or more of the following advantages.

By using the techniques described in this specification, failure cases from a trained neural network, e.g., a large-scale vision model or other model that processes sensor data captured by one or more sensors, can be automatically discovered under real-world settings. In particular, the described techniques use off-the-shelf, large-scale, generative models, e.g., image-to-text and text-to-image models, to automatically find such failures. Thus, the described techniques can effectively discover failures without requiring any additional model training.

Many machine learning models exhibit numerous failures arising from using shortcuts and learning spurious correlations. It is important to find failure cases to ensure that models are robust and generalize to new deployment settings. Very few tools exist to automatically find failure cases on unseen data. Some methods analyze the performance of models by collecting new datasets. These datasets must be large enough to obtain some indication of how models perform on a particular subset of inputs. These methods are difficult to use when a large amount of data is not available. Other methods rely on expertly crafted, synthetic (and often unrealistic) datasets that highlight particular shortcomings.

By using the techniques described in this specification, e.g., by leveraging large-scale, text-to-image, generative models, it is much less difficult to obtain large and realistic datasets that can be reliably manipulated. The generative models are trained on web-scale datasets and can be re-used and have broad non-domain-specific coverage. They can generate large amounts of novel data and can realistically capture the essence of (most) subsets of inputs. This allows for automatic identification of a greater variety of realistic failure cases.

### BRIEF DESCRIPTION OF THE DRAWINGS

FIG. 1 shows an example failure case determination system.

FIG. 2 is a flow diagram of an example process for determining failure case latent representations from initial network inputs.

FIG. 3 is a flow diagram of an example process for determining one or more failure case latent representations based on a subset of initial network inputs.

FIG. 4 shows an example of determining a failure case for an image classification task.

FIG. 5 shows an example failure distribution for the image classification task of FIG. 4.

Like reference numbers and designations in the various drawings indicate like elements.

### DETAILED DESCRIPTION

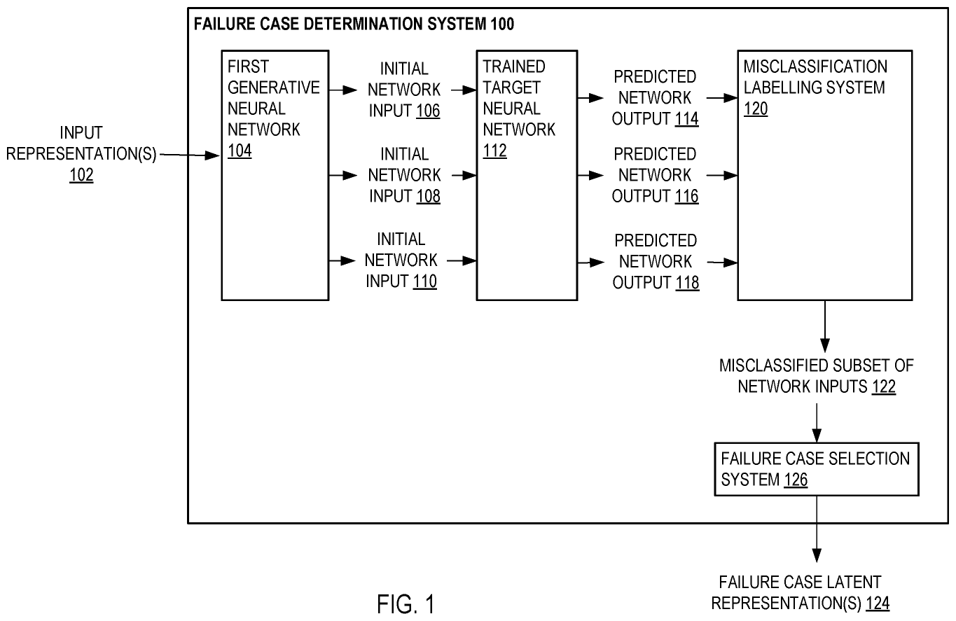

FIG. 1 shows an example failure case determination system 100. The failure case determination system 100 is an example of a system implemented as computer programs on one or more computers in one or more locations in which the systems, components, and techniques described below are implemented.

The failure case determination system 100 processes one or more input representations 102 to determine one or more failure case latent representations 124 for a trained target neural network 112.

The trained target neural network 112 is a neural network that has been trained to perform a classification task. The trained target neural network 112 may be implemented as any appropriate neural network model, for example, as a vision transformer neural network or a convolutional neural network. The trained target neural network 112 classifies inputs as belonging to a class from a set of multiple classes.

As used in this specification, a classification task is any task that requires the trained target neural network 112 to generate an output 114, 116, and 118 for each network input 106, 108, and 110 that includes a respective score for each of a set of multiple classes and, in some cases, to then select one or more of the classes as a “classification” for the network input using the respective scores.

One example of a classification task is image classification, where the initial network inputs 106, 108, and 110 to the trained target neural network 112 are images, i.e., the intensity values of the pixels of the image, the categories are object categories, and the task is to classify the image as depicting an object from one or more of the object categories. That is, the classification for a given input image is a prediction of one or more object categories that are depicted in the input image. For example, the categories can represent different natural objects that can be depicted in the image. As another example, the images can be medical images and the categories can represent different types of tissue that can be depicted in the image, and/or they can represent different states of one or more medical conditions. In some examples, the images may be frames of a video.

Another example of a classification task is text classification, where the initial network inputs 106, 108, and 110 to the trained target neural network 112 are text and the task is to classify the text as belonging to one of multiple categories. One example of such a task is a sentiment analysis task, where the categories each correspond to different possible sentiments of the text. Another example of such a task is a reading comprehension task, where the input text includes a context passage and a question and the categories each correspond to different segments from the context passage that might be an answer to the question. Other examples of text processing tasks that can be framed as classification tasks include an entailment task, a paraphrase task, a textual similarity task, a sentiment task, a sentence completion task, a grammaticality task, a text translation task and so on. In one example, the text classification task may comprise a text translation task in which the initial network inputs each comprise text in a first language and a corresponding candidate translation of the text in a second language and the trained target neural network classifies whether the candidate translation is a correct translation of the text in the first language into the second language. The first and second languages may be natural languages.

Other examples of classification tasks include audio processing tasks where the initial network inputs 106, 108, and 110 to the trained target neural network 112 are audio data. Some examples of audio processing tasks are speech processing tasks, where each input to the trained target neural network 112 is audio data representing speech. Examples of speech processing tasks include language identification (where the categories are different possible languages for the speech), hotword identification (where the categories indicate whether one or more specific “hotwords” are spoken in the audio data), speaker identification (where the categories are different persons who may have spoken in the audio data) and so on. Other examples of audio processing tasks are tasks that require processing audio data other than speech, e.g., audio event classification (where the categories are different types of audio events that can be audible in the audio data), environmental sound classification (where the categories represent different animals that can make the sound audible in the audio data, or, more generally, different objects that can generate the sound audible in the audio data).

Other examples of classification tasks include video processing tasks where the initial network inputs 106, 108, 110 to the trained target neural network 112 comprise video data.

More generally, the classification task may be classification of one or more of: digital images, videos, audio or speech signals, or other sensor data obtained from one or more sensors. If the classification task comprises classifying an image or video, the initial network inputs may comprise intensity values of the pixels of the image or of one or more frames of the video. If the classification task comprises classifying audio or speech signals, the initial network inputs may comprise e.g. waveform data.

The trained target neural network 112 can have been trained on a set of training data using an objective function that is appropriate for the classification task. That is, the described techniques are generally applicable to discovering failure case latent representations 124 for any trained neural network.

The one or more input representations 102 describe a ground truth class from the plurality of classes for the classification task. A ground truth class is a class of interest for which the system 100 tries to find failure case latent representations 124.

An input representation can be a latent representation that characterizes the ground truth class.

A latent representation is an alternative representation of data that characterizes the important features of the data.

For example, an input representation can be a text caption that describes the ground truth class. As a particular example, the ground truth class can be “persian cat”. A latent representation of the ground truth class can be “a realistic photo of a persian cat (domestic animal”.

A “failure case” is a network input that is likely to be misclassified by the trained target neural network 112.

A failure case latent representation 124 is a latent representation that characterizes failure cases, i.e., that characterizes network inputs that are likely to be misclassified by the trained neural network 112. For example, the failure case latent representations 124 can be text captions that describe network inputs, e.g., as generated by a captioning neural network by processing the network input.

The failure case determination system 100 can process each of the one or more input representations 102 using a first generative neural network 104 to generate one or more initial network inputs 106, 108, and 110 that are conditioned on the input representation 102.

The first generative neural network 104 can be implemented as any appropriate neural network model that generates outputs of the same type that the trained target neural network 112 is configured to classify, conditioned on an input that is of the same type as the input representations 102.

For example, an input representation 102 can be a text prompt that describes the ground truth class. In this example, the first generative neural network 104 can be a neural network that is trained to generate initial network inputs 106, 108, and 110 that are described by input text prompts 102. As a particular example, when the target neural network 112 is configured to classify images, the first generative neural network 104 can be a text-to-image model that maps inputs that include text to images.

The first generative neural network 104 can generate multiple different initial network inputs from one input representation by stochastically sampling multiple different outputs from the first generative neural network while the first generative neural network is conditioned on a given input. In the example where when the target neural network 112 is configured to classify images, the first generative neural network 104 can receive a text prompt as an input representation and generate multiple images as initial network inputs.

The system 100 then processes each initial neural network input 106, 108, and 110 using the trained target neural network 112 to generate a respective predicted network output 114, 116, and 118.

A given initial network input 106, 108, and 110 can be determined to be “likely” to be misclassified by the trained target neural network 112 when the system predicts that the likelihood that the trained target neural network will misclassify the network input exceeds a baseline misclassification rate by more than a specified amount.

The specified amount is a value greater than or equal to zero.

The baseline misclassification rate can be specified by a user or can be determined by determining the rate at which the trained neural network 112 misclassifies inputs to the trained neural network.

An initial network input 106, 108, and 110 can be determined as “misclassified” by the trained target neural network 112 based on any of a variety of criteria. Generally, a network input 106, 108, and 110 is misclassified when the respective predicted output 114, 116, and 118 generated by the trained target neural network 112 by processing the network input is inconsistent with the known, ground truth class to which the network input has been classified as belonging.

In the context of FIG. 1, an initial network input 106, 108, and 110 can be determined as misclassified when the respective predicted network output 114, 116, and 118 for the network input from the trained target neural network 112 does not correspond to the ground truth class. That is, the system 100 identifies the ground truth class as the known class to which the network input has been classified as belonging because the initial network inputs were generated by the first generative neural network conditioned on the input representation(s) 102 of the ground truth class.

In some examples, a network input 106, 108, and 110 is considered misclassified only when none of the top K classes according to the probabilities in the predicted network output for the network input are the same as the ground truth class, where K is a predetermined integer greater than or equal to 1. That is, the network input is considered to be misclassified when the ground truth class is not in the top K classes according to the scores in the network output for the network input.

The system 100 can use a misclassification labelling system 120 to process the predicted network outputs 114, 116, and 118 to identify a subset 122 of the initial network inputs that have been misclassified by the trained target neural network.

The system 100 can use a failure case selection system 126 to process the subset 122 of the initial network inputs that have been classified to generate one or more failure case latent representations 124.

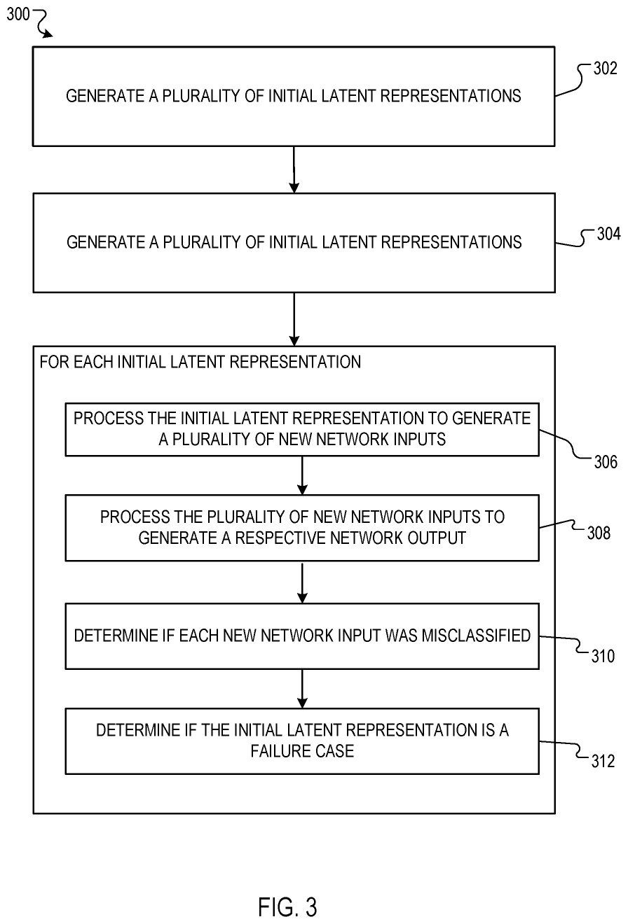

Generating failure case latent representations 124 is further described below with reference to FIG. 3.

The system 100 can use the failure case latent representations 124 in any of a variety of ways.

As one example, the system 100 can use the failure case latent representations 124 to further train the trained target neural network 112 to improve the accuracy of the trained target neural network. In some implementations, the system 100 can generate a plurality of training examples using the one or more failure case latent representations 124. Each training example can include a network input characterized by a respective one of the one or more failure case latent representations 124 and a target network output that identifies the ground truth class. The system can further train the trained target neural network 112 on training data that includes the plurality of training examples to improve the performance of the trained target neural network 122 in accurately classifying network inputs that belong to the ground truth class.

As another example, the system 100 can use the failure case latent representations 124 to determine whether a given new input is likely to be misclassified by the trained target neural network 112, i.e., without further training the trained target neural network 112.

That is, when the system 100 receives a new network input, the system can determine a latent representation of the new network input and use the latent representation of the new network input and the failure case latent representations 124 to determine how likely the neural network 112 is to misclassify the new input, e.g., based on a similarity between the latent representation of the new network input and the one or more failure case latent representations.

For example, the system 100 can generate a measure of uncertainty of an accuracy of a network output generated by the target neural network for the new network input based on a similarity between the latent representation of the new network input and the one or more failure case latent representations 124. The system 100 can then provide the measure of uncertainty along with the network output, can determine whether to provide a network output generated by the trained target neural network for the new network input based on the measure of uncertainty, or both.

As another example, the system 100 can use the failure case latent representations 124 to determine whether to deploy the trained target neural network 112 for processing new network inputs. For example, if the number of failure case latent representations is greater than a predetermined threshold number, the system 100 can decide to not deploy the trained target neural network 112. As another example, the system can obtain a set of test data that includes multiple inputs. The system 100 can decide to not deploy the trained target neural network if the average measure of uncertainty for the inputs in the set of test data is too high or if too many of the test inputs have a measure of uncertainty above a predetermined threshold.

In some implementations, the system can generate failure case latent representations 124 for multiple different ones of the plurality of classes e.g., the failure case latent representations can represent more than one ground truth class.

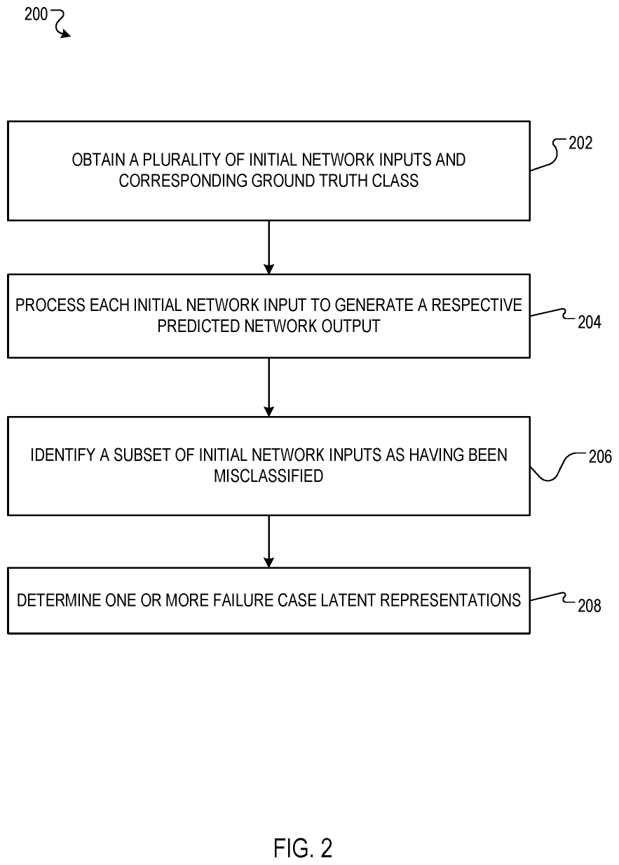

FIG. 2 is a flow diagram of an example process 200 for determining failure case latent representations from initial network inputs. For convenience, the process 200 will be described as being performed by a system of one or more computers located in one or more locations. For example, a failure case determination system, e.g., the failure case determination system 100 of FIG. 1, appropriately programmed in accordance with this specification, can perform the process 200. In practice, the system can perform the example process 200 for all classes in a set of classes to obtain failure case latent representations for multiple classes. In some examples, the system can perform the example process 200 for a designated subset of the classes.

The system obtains a plurality of initial network inputs that have been classified as belonging to a corresponding ground truth class (step 202).

In some implementations, the system generates or receives as input one or more input representations that describe the ground truth class.

For each of the one or more input representations, the system uses a first generative neural network to process the input representation to generate one or more initial network inputs that are conditioned on the input representation. For example, each input representation can be a respective text prompt that describes the ground truth class and the first generative neural network can be trained to generate network outputs that are described by input text prompts.

In some other implementations, the system directly receives the initial network inputs as input, e.g., from a user.

The system uses a trained target neural network to process each of the plurality of initial network inputs to generate a respective predicted network output for each initial network input (step 204). The respective predicted network output includes a respective score for each of a plurality of classes. The plurality of classes includes the ground truth class.

In some implementations, the network inputs can represent measurements captured by one or more sensors e.g., camera sensors, audio sensors, or sensors that sense an environment being interacted with by an agent. In some implementations, the environment is a real-world environment, and the agent is a mechanical agent interacting with the real-world environment. The sensors that sense the environment being interacted with by an agent can be sensors of the agent e.g., a camera of the agent, a laser sensor of the agent, a motion sensor of the agent, or a hyperspectral sensor of the agent. The predicted network outputs can be classification outputs across different objects or across actions to be performed by the agent. That is, the trained neural network may classify network inputs as part of an agent control task in which one or more predicted network outputs are used to determine one or more actions for the agent to perform in the real-world environment. For example, the agent may be a robot or vehicle interacting with the environment to accomplish a specific task, e.g., to locate an object of interest in the environment or to move an object of interest to a specified location in the environment or to navigate to a specified destination in the environment. When performing the task, the agent may perform an action in response to a predicted network output corresponding to a particular object having been detected in the real-world environment. For example, where the agent is an autonomous or semi-autonomous vehicle, the network output may be used to generate a control signal to cause the vehicle to change the course or speed of the vehicle, e.g. to avoid a collision with a detected object.

The system identifies, based on the respective predicted network outputs and the ground truth class, a subset of the initial network inputs as having been misclassified by the trained target neural network (step 206). A network input can be determined as misclassified when the respective predicted network output from the trained target neural network does not correspond to the ground truth class. The system can determine that a network input was misclassified based at least on a respective score assigned to the ground truth class by the respective predicted network output for the new network input. In some examples, the network input is considered to be misclassified when the ground truth class is not in the top K classes according to the scores in the network output for the network input.

The system determines, based on the subset of initial network inputs, one or more failure case latent representations (step 208).

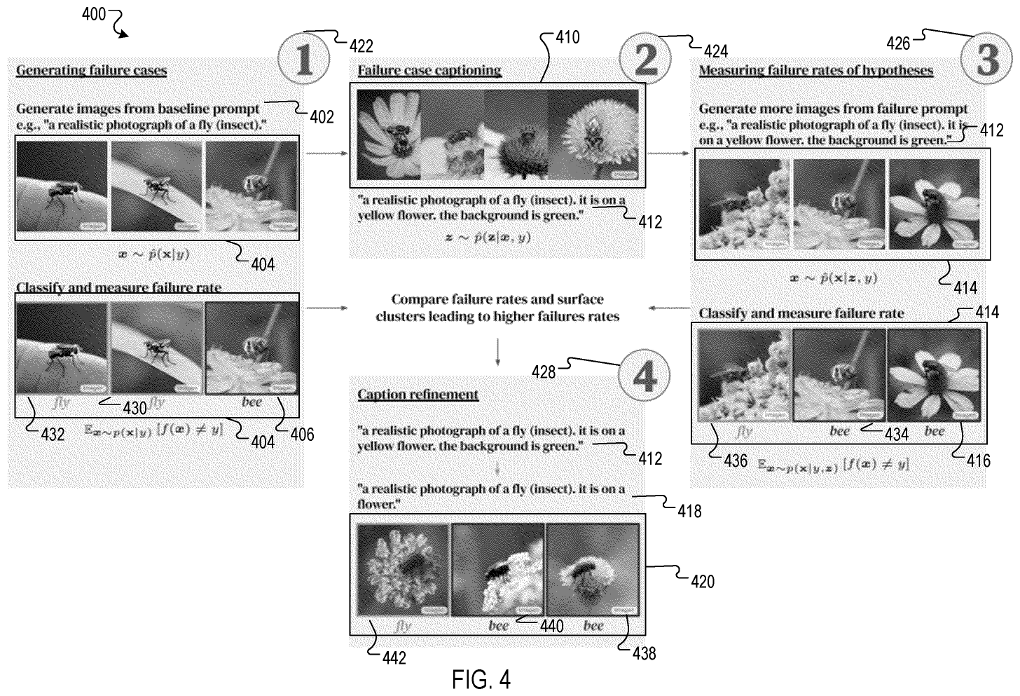

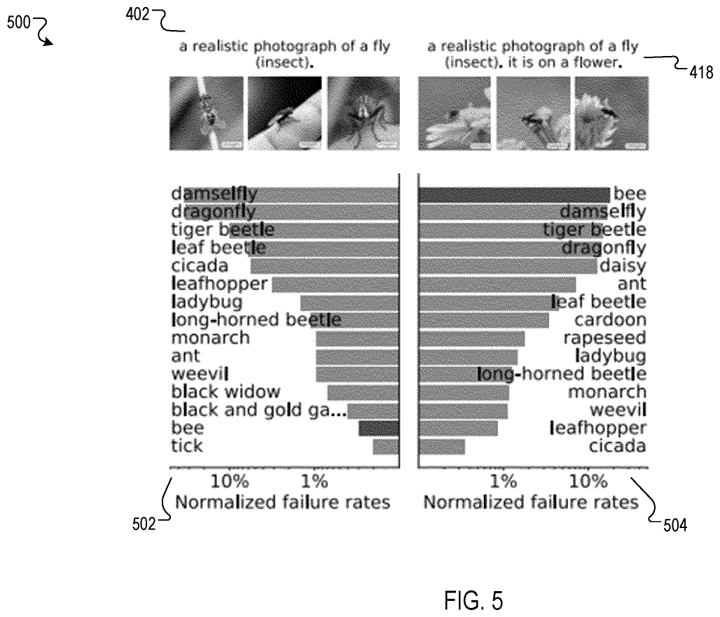

Each failure case latent representation is a latent representation that characterizes network inputs that belong to the ground truth class but that are likely to be misclassified by the trained target neural network. Specific examples of latent representations are described below with reference to FIGS. 4 and 5.

Determining a failure case latent representation is further described below with reference to FIG. 3.

FIG. 3 is a flow diagram of an example process 300 for determining one or more failure case latent representations based on a subset of initial network inputs. For convenience, the process 300 will be described as being performed by a system of one or more computers located in one or more locations. For example, a failure case determination system, e.g., the failure case determination system 100 of FIG. 1, appropriately programmed in accordance with this specification, can perform the process 300.

The system obtains a subset of initial network inputs that have been classified as belonging to a corresponding ground truth class and that have been misclassified by a trained target neural network (step 302). The subset can be e.g., the subset determined in step 206 of FIG. 2.

The system generates, based on the subset of initial network inputs, a plurality of initial latent representations (step 304).

In some implementations, the system can use a latent representation neural network to process each initial network input in the subset to generate a latent representation that characterizes the initial network input. The latent representation neural network can be any appropriate neural network that is configured to process an initial network input and generate a latent representation that characterizes the initial network input e.g., an image-to-text captioning model.

In some other implementations, the system can generate the plurality of initial latent representations by first clustering the initial network inputs in the subset into a plurality of clusters. The system can use any appropriate clustering technique to cluster the initial network inputs in the subset, e.g., k-means clustering or fuzzy clustering.

The system can determine that a portion of initial latent representations have similar feature representations. For example, the system can use the distance between intermediate activations of a pretrained model i.e., outputs of a predetermined hidden layer of the pretrained model, to cluster the network inputs using any appropriate clustering technique. The pretrained model can be, for example, the trained target neural network of FIG. 1.

For each cluster, the system can generate an initial latent representation for the cluster. To generate the initial latent representation, the system can use a latent representation neural network to process each of one or more of the initial network inputs in the cluster to generate a respective latent representation that characterizes each of the one or more initial network inputs.

The system can generate the initial latent representation for the cluster from the respective latent representations that characterize the one or more initial network inputs in the cluster. In some examples, the system can combine portions of the respective latent representations that characterize the one or more initial network inputs in the cluster. The system can combine portions to maximize a likelihood assigned to the initial latent representation by the latent representation neural network. For example, given an initial network input in the cluster, the system can compute the likelihood of a candidate latent representation given that initial network input and all previously chosen latent representations using the latent representation neural network. The system can average this likelihood over all generated network inputs and choose the candidate latent representation that maximizes this likelihood as the initial latent representation.

In some examples, the latent representations can be text captions and the latent representation neural network can be any neural network that has been trained to process a network input to generate a text caption that describes the network input e.g., a visual language model.

For each initial latent representation, the system uses a second generative neural network to process the initial latent representation to generate a plurality of new network inputs conditioned on the initial latent representation (step 306). The second generative neural network may be implemented as any appropriate neural network model that generates outputs of the same type that the trained target neural network is configured to classify, conditioned on an input that is of the same type as the initial latent representation, for example, as a text-to-image model.

In some implementations, the second generative neural network is the same as the first generative neural network described above with reference to FIGS. 1 and 2.

The system can use the second generative neural network to process the initial latent representation and at least one of the one or more input representations to generate the plurality of new network inputs. For example, the original input representation can be a text prompt reading “a snow leopard” and the initial latent representation can be a text prompt reading “with a green background”. The system can create a new input representation that is a concatenation of the original input representation and the initial latent representations reading “a snow leopard with a green background”. The system can use the second generative neural network to process the new input representation and generate new network inputs.

The system uses the trained target neural network to process the plurality of new network inputs to generate a respective predicted network output for each new network input (step 308).

The system determines, for each new network input, whether the new network input was misclassified by the trained target neural network (step 310). The system can determine that a network input was misclassified based at least on a respective score assigned to the ground truth class by the respective predicted network output for the new network input. In some examples, the network input is considered to be misclassified when the ground truth class is not in the top K classes according to the scores in the network output for the network input.

The system can determine whether to select the initial latent representation as a failure case latent representation based on how many of the new network inputs were misclassified by the trained target neural network (step 312).

In some implementations, the system can determine to select the initial latent representation as a failure case latent representation when a misclassification rate for the new network inputs exceeds a baseline misclassification rate by at least a specified amount. In some examples, the baseline misclassification rate can be based on how many of the initial network inputs were misclassified by the trained target neural network. In other examples, the baseline misclassification rate can be specified by a user.

FIG. 4 shows an example 400 of determining a failure case for an image classification task. For convenience, the example is described as being performed by a system. FIG. 4 shows four steps 422, 424, 426, and 428.

The first step 422 shows a set of three images 404 generated from a baseline text prompt 402 that describes a class of interest. The baseline text prompt 402 reads “a realistic photograph of a fly (insect)” and describes the class “fly”. That is, in the example of FIG. 4, the baseline text prompt 402 is an input representation of a ground truth class “fly.”

The set of images 404 approximate generic images sampled from an underlying marginal distribution for a trained target neural network.

In this example, the trained target neural network is an image classifier f: X→Y where X is the set of inputs (i.e., images) and Y is the set of classes The underlying marginal distribution can be represented as p(x|y). Since the system does not have access to the true underlying distribution p(x|y), the system leverages a first generative neural network to approximate the distribution and generate the set of images 404. In this example, the first generative neural network is a large-scale text-to-image model.

Example architectures for the large-scale text-to-image model include DALL•E 2 (Ramesh et al., 2022), IMAGEN (Saharia et al., 2022) and STABLE-DIFFUSION (Rombach et al., 2022).

Once the system generates the set of images 404, the system classifies each image in the set using the image classifier. In this example, the system correctly classifies two of the images 430 and 432 in the set of images 404 as having the correct class of “fly”. The system misclassifies one image 406 in the set of images 404 as having the class “bee”. The determined class for an image is the class with the highest score from the corresponding predicted network output. An image can be determined as misclassified when the predicted class from the image classifier does not match the class of interest y. In some examples, an image is considered misclassified only when any of the top K predicted labels for an image are not the same as the class of interest y, where K is an integer greater than or equal to 1.

The output of the step 422 is a set 404 of N images generated from the baseline text prompt, a set of misclassified images, and an estimate of the baseline failure rate. The baseline failure rate can be calculated as the number of misclassified images divided by N, the number of images in the set 404. In this example, the failure rate is 33.3%.

The step 424 shows a set of images 410 that represents a cluster of misclassified images for the given class of interest y. The set of images 410 are a misclassified subset of network inputs. The system can determine that a portion of misclassified images have similar feature representations. For example, the system can use the cosine distance between intermediate activations of a pretrained model to group similar misclassified images.

In this example, the system processes one cluster of misclassified images. However, in other examples, the system can process multiple clusters of misclassified images. In other examples, the system does not divide the misclassified images into clusters with similar feature representations and processes all misclassified images simultaneously.

For the set of images 410 that represents a cluster of misclassified images, the system generates a proposed failure case caption 412 that describes the images in the cluster using an image-to-text captioning model. Example architectures of the image-to-text captioning model include FLAMINGO (Alayrac et al., 2022) and LEMON (Hu et al., 2021). The system can require that the captioning model only considers completions to the original baseline prompt to guarantee that the proposed failure case caption 412 contains the class of interest y. The proposed failure case caption 412 is a hypothesis for a failure case.

The proposed failure case caption 412 can be represented by z and can be conditioned on the class of interest y and each image in the set of images 410 that represents a cluster of misclassified images e.g., z˜p(z|x,y). The goal of this step is to find a proposed failure case caption 412 that that maximizes the likelihood of sampling elements that are in the set of images 410 representing the cluster.

The step 426 shows a set of three generated images 414 that the system generates from the proposed failure case caption 412. The images in the set of generated images 414 resemble the images in the set of images 410 that represent the cluster of misclassified images but are not identical. The set of images 414 approximate images from an underlying marginal distribution p(x|z,y) for an image classifier f: X→Y where z is the proposed failure case caption 412. Since the system does not have access to the true underlying distribution p(x|z,y), the system leverages a large-scale text-to-image model to approximate the distribution and generate the set of generate images 414. In this example, the system uses the same large-scale text-to-image model used in step 422.

Once the system generates the set of images 414, the system classifies each image in the set using the image classifier. In this example, the system correctly classifies one image 436 in the set of images 414 as having the correct class of “fly”. The system misclassifies two images 434 and 416 in the set of images 414 as having the class “bee”.

The system calculates the new failure rate for the set 414 of generated images as the number of misclassified images in the set over the number of images in the set. In this example, the new failure rate is 66.7%. The system compares the new failure rate with the baseline failure rate. In this example, since the new failure rate of 66.7% is higher than the baseline failure rate of 33.3%, the system determines that the proposed failure case caption 412 describes a failure case. In other examples, the system can require that the new failure rate must exceed the baseline failure rate by a predetermined threshold for the proposed failure case caption to be determined as a failure case.

In some implementations, the system can refine one or more of the failure case latent representations e.g., to generate a failure case latent representation that is more condensed than the original failure case latent representation. This helps the system identify characteristics in the network inputs that result in failure cases.

Step 428 shows a refined caption 418 derived from the proposed failure case caption 412. The system can evaluate the proposed failure case caption 412 and generate a shorter caption 418 that that obtains a similar failure rate. This is done in order to focus the refined caption 418 on the characteristics of the proposed failure case caption 412 that are causing the image to be misclassified.

In this example, the system evaluates all individual phrases in the caption in conjunction with the baseline text prompt 402. For this example, the individual phrases can be “it is on a yellow flower” and “the background is green” and the original text prompt is “a realistic photograph of a fly (insect)”. In this example, the most promising text prompt is further refined by dropping adjectives. For example, the system can drop the adjective “yellow” in “it is on a yellow flower”. After evaluating all individual phrases and dropping adjectives, the system generates the refined caption 418 that describes the failure case.

Removing “yellow” shows that the failure case can be described as when the fly is on a flower regardless of the color. Removing “the background is green” shows that the background color is not driving the misclassification. In this particular example, the characteristic that results in misclassification is that the fly is on a flower.

In this example, the refined caption 418 reads “a realistic photograph of a fly (insect). it is on a flower”. The refined caption 418 is a failure case latent representation. The system generates a set of images 420 based on the refined caption 418. The system correctly classifies one image 438 in the set of images 420 as having the correct class of “fly”. The system misclassifies two images 440 and 442 in the set of images 420 as having the class “bee”. The refined caption 418 obtains the same failure rate of 66.7% as the new failure rate for the proposed failure rate caption 412. Thus, the refined caption 418 is both shorter and obtains a similar failure rate.

In some examples, since the captions are readable by humans, users can interact with the system and test alternative captions. For example, a human can input an input representation to the system with specific proposed failure case captions to test various hypotheses of interest.

FIG. 5 shows an example failure distribution for the classification task of FIG. 4. FIG. 5 shows two graphs 502 and 504. The graph 502 on the left shows the normalized distribution of failure rates for the baseline class “fly” for images generated from the baseline caption 402 reading “a realistic photograph of a fly (insect)”. The graph 504 on the right shows the normalized distribution of failure rates for the refined class “fly on a flower” for images generated from the refined caption 418 reading “a realistic photograph of a fly (insect). it is on a flower”. Each graph 502 and 504 shows the fifteen most common misclassified classes for the images generated from the respective captions 402 and 418. Each graph 502 and 504 shows the failure rate for each misclassified class.

The graph 502 for the baseline caption 402 shows that the most common misclassification is “damselfly” and the 14^{th} most common misclassification is “bee”. The graph 504 for the refined caption 418 shows that the most common misclassification is “bee”. This indicates that the classifier is significantly more likely to misclassify flies as bees when they are on flowers. There is also large increase in failure rates when the system uses the refined caption 418 to generate images, e.g., by adding “it is on a flower” to the baseline caption. The system identifies the refined caption 418 as a failure case latent representation and can further train the image classifier using the refined caption to improve its accuracy. Each training example can include an image described by the refined caption 418 and classification output that identifies the ground truth class as “fly”. This can prevent the image classifier from making the same misclassifications.

Similarly, the system can find failure cases for audio classification tasks. The system can generate multiple audio network inputs from an input representation baseline text prompt describing a class of interest using an audio generation model e.g., AudioLM or AudioPaLM. The system can use an audio classifier to classify each network input and determine which network inputs the classifier misclassified. The system can calculate a failure rate for the audio network inputs generated from the baseline text prompt.

The system can identify a cluster of misclassified audio network input for the given class of interest that are a subset of misclassified network inputs. For the set of audio network inputs that represents a cluster of misclassified audio network inputs, the system can generate a proposed failure case caption that describes the images in the cluster using an audio-to-text captioning model e.g., AudioPaLM.

The system can generate, from the proposed failure case caption, a set of new audio network inputs that represent the cluster of misclassified network inputs but are not identical. The system can classify each audio network input in the new set using the audio classifier. The system can calculate the new failure rate for the new set of generated audio network inputs as the number of misclassified inputs in the set over the number of inputs in the set. The system can compare the new failure rate with the baseline failure rate to determine if the cluster represents a failure case. The system can refine the caption to generate a refined caption that is more condensed than the original proposed failure case caption.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

In this specification, the term “database” is used broadly to refer to any collection of data: the data does not need to be structured in any particular way, or structured at all, and it can be stored on storage devices in one or more locations. Thus, for example, the index database can include multiple collections of data, each of which may be organized and accessed differently.

Similarly, in this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a key vectorboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework, a Microsoft Cognitive Toolkit framework, an Apache Singa framework, or an Apache MXNet framework.

Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method performed by one or more computers, the method comprising:
obtaining a plurality of initial network inputs that have been classified as belonging to a corresponding ground truth class;
processing each of the plurality of initial network inputs using a trained target neural network to generate a respective predicted network output for each initial network input, the respective predicted network output comprising a respective score for each of a plurality of classes, the plurality of classes comprising the ground truth class;
identifying, based on the respective predicted network outputs and the ground truth class, a subset of the initial network inputs as having been misclassified by the trained target neural network; and
determining, based on the subset of initial network inputs, one or more failure case latent representations, wherein each failure case latent representation is a latent representation that characterizes network inputs that belong to the ground truth class but that are likely to be misclassified by the trained target neural network.

2. The method of claim 1, wherein the trained target neural network processes network inputs that represent measurements captured by one or more sensors.

3. The method of claim 2, wherein the measurements comprise images captured by one or more camera sensors.

4. The method of claim 2, wherein the measurements comprise audio captured by one or more audio sensors.

5. The method of claim 2, wherein the measurements comprise observations captured by one or more sensors that sense an environment being interacted with by an agent.

6. The method claim 1, wherein obtaining a plurality of initial network inputs that have been classified as belonging to a corresponding ground truth class comprises:
generating one or more input representations that describe the ground truth class; and
for each of the one or more input representations, processing the input representation using a first generative neural network to generate one or more initial network inputs that are conditioned on the input representation.

7. The method of claim 6, wherein each input representation is a respective text prompt that describes the ground truth class and wherein the first generative neural network has been trained to generate network outputs that are described by input text prompts.

8. The method of claim 1, wherein determining, based on the subset of initial network inputs, one or more failure case latent representations comprises:
generating, based on the subset of initial network inputs, a plurality of initial latent representations;
for each initial latent representation:
processing the initial latent representation using a second generative neural network to generate a plurality of new network inputs conditioned on the initial latent representation;
processing the plurality of new network inputs using the trained target neural network to generate a respective predicted network output for each new network input;
determining, for each new network input, whether the new network input was misclassified by the trained target neural network based at least on a respective score assigned to the ground truth class by the respective predicted network output for the new network input; and
determining whether to select the initial latent representation as a failure case latent representation based on how many of the new network inputs were misclassified by the trained target neural network.

9. The method of claim 8, wherein determining whether to select the initial latent representation as a failure case latent representation comprises:
determining to select the initial latent representation as a failure case latent representation when a misclassification rate for the new network inputs exceeds a baseline misclassification rate by at least a specified amount.

10. The method of claim 9, wherein the baseline misclassification rate is based on how many of the initial network inputs were misclassified by the trained target neural network.

11. The method of claim 8, wherein generating, based on the subset of initial network inputs, a plurality of initial latent representations comprises:
processing each initial network input in the subset using a latent representation neural network to generate a latent representation that characterizes the initial network input.

12. The method of claim 8, wherein generating, based on the subset of initial network inputs, a plurality of initial latent representations comprises:
clustering the initial network inputs in the subset into a plurality of clusters;
for each cluster, generating an initial latent representation for the cluster, comprising:
processing each of one or more of the initial network inputs in the cluster using a latent representation neural network to generate a respective latent representation that characterizes each of the one or more initial network inputs; and
generating the initial latent representation for the cluster from the respective latent representations that characterize the one or more initial network inputs in the cluster.

13. The method of claim 12, wherein generating the initial latent representation for the cluster from the respective latent representations that characterize the one or more initial network inputs in the cluster comprises:
combining portions of the respective latent representations that characterize the one or more initial network inputs in the cluster.

14. The method of claim 13, wherein combining portions comprises:
combining portions to maximize a likelihood assigned to the initial latent representation by the latent representation neural network.

15. The method of claim 11, wherein the latent representations are text captions and wherein the latent representation neural network has been trained to process a network input to generate a text caption that describes the network input.

16. (canceled)

17. (canceled)

18. The method of claim 1, further comprising:
generating a plurality of training examples using the one or more failure case latent representations, wherein each training example includes (i) a network input characterized by a respective one of the one or more failure case latent representations and (ii) a target network output that identifies the ground truth class; and
further training the trained target neural network on training data that includes the plurality of training examples.

19. The method of claim 1, further comprising:
receiving a new network input;
determining a latent representation of the new network input; and
determining whether to provide a network output generated by the target neural network for the new network input based on a similarity between the latent representation of the new network input and the one or more failure case latent representations.

20. The method of claim 1, further comprising:
receiving a new network input;
determining a latent representation of the new network input; and
generating a measure of uncertainty of an accuracy of a network output generated by the target neural network for the new network input based on a similarity between the latent representation of the new network input and the one or more failure case latent representations.

21. The method of claim 1, further comprising:
determining whether to deploy the trained target neural network for processing new network inputs based on the one or more failure case latent representations.

22. (canceled)

23. A method performed by one or more computers, the method comprising:
obtaining a plurality of network inputs that have been classified as belonging to a corresponding ground truth class and that have been misclassified by a trained target neural network;
generating, from the plurality of network inputs, a plurality of latent representations that each characterize one or more of the network inputs;
for each latent representation:
processing the latent representation using a first generative neural network to generate a plurality of new network inputs characterized by the latent representation;
processing each of the new network inputs using the trained target neural network to generate a respective predicted network output for each new network input, the respective predicted network output comprising a respective score for each of a plurality of classes, the plurality of classes comprising the ground truth class; and
determining, based on the respective predicted network outputs for the new network inputs, whether the latent representation is a failure case, wherein a failure case is a latent representation that characterizes network inputs that belong to the ground truth class but that are likely to be misclassified by the trained target neural network.

24. The method of claim 23, wherein obtaining a plurality of network inputs comprises:
obtaining a plurality of initial network inputs that have been classified as belonging to the corresponding ground truth class;
processing each of the plurality of initial network inputs using the trained target neural network to generate a respective predicted network output for each initial network input; and
identifying, based on the respective predicted network outputs and the ground truth class, a subset of the initial network inputs as having been misclassified by the trained target neural network.

25. The method of claim 23, wherein the latent representations are text captions that each describe one or more of the network inputs.

26. (canceled)

27. (canceled)

28. (canceled)

29. (canceled)

30. The method of claim 24, wherein obtaining a plurality of initial network inputs that have been classified as belonging to the corresponding ground truth class comprises:
generating one or more input representations that describe the ground truth class; and
for each of the one or more input representations, processing the input representation using a second generative neural network to generate one or more initial network inputs that are conditioned on the input representation.

31. The method of claim 30, wherein each input representation is a respective text prompt that describes the ground truth class and wherein the first generative neural network has been trained to generate network outputs that are described by input text prompts.

32. The method of claim 23, wherein determining, based on the respective predicted network outputs for the new network inputs, whether the latent representation is a failure case comprises:
determining, for each new network input, whether the new network input was misclassified by the trained target neural network based at least on a respective score assigned to the ground truth class by the respective predicted network output for the new network input; and
determining whether to select the latent representation as a failure case based on how many of the new network inputs were misclassified by the trained target neural network.

33. The method of claim 32, wherein determining whether to select the latent representation as a failure case comprises:
determining to select the initial latent representation as a failure case when a misclassification rate for the new network inputs exceeds a baseline misclassification rate by at least a specified amount.

34. (canceled)

35. The method of claim 23, wherein generating, from the plurality of network inputs, a plurality of latent representations that each characterize one or more of the network inputs comprises:
processing each network input using a latent representation neural network to generate a latent representation that characterizes the network input.

36. The method of claim 23, wherein generating, from the plurality of network inputs, a plurality of latent representations that each characterize one or more of the network inputs comprises
clustering the network inputs into a plurality of clusters;
for each cluster, generating a latent representation for the cluster, comprising:
processing each of one or more of the network inputs in the cluster using a latent representation neural network to generate a respective latent representation that characterizes each of the one or more network inputs; and
generating the latent representation for the cluster from the respective latent representations that characterize the one or more network inputs in the cluster.

37. (canceled)

38. (canceled)

39. The method of claim 35, wherein the latent representations are text captions and wherein the latent representation neural network has been trained to process a network input to generate a text caption that describes the network input.

40. (canceled)

41. (canceled)

42. (canceled)

43. (canceled)

44. (canceled)

45. (canceled)

46. A method performed by one or more computers, the method comprising:
obtaining a plurality of images that have been classified as belonging to a corresponding ground truth class and that have been misclassified by a trained target neural network;
generating, from the plurality of initial images, a plurality of text captions that each describe one or more of the images;
for each text caption:
processing the text caption using a first generative neural network to generate a plurality of new images described by the text caption;
processing each of the new images using a trained target neural network to generate a respective predicted network output for each new image, the respective predicted network output comprising a respective score for each of a plurality of classes, the plurality of classes comprising the ground truth class; and
determining, based on the respective predicted network outputs for the new images, whether the text caption is a failure case, wherein a failure case is a text caption that describes images that belong to the ground truth class but that are likely to be misclassified by the trained target neural network.

47. (canceled)

48. (canceled)
